(19) United States
(12) Patent Application Publication
(10) Pub. No.: US 2020/0390070 A1
(43) Pub. Date: Dec. 17, 2020

(54) AQUARIUM POWER ADAPTER AND AQUARIUM POWER SUPPLY SYSTEM COMPRISING THE SAME

(71) Applicant: EIKO ELECTRIC PRODUCTS CORP., TAIPEI CITY (TW)

(72) Inventor: Yu-Chin WANG, Taipei City (TW)

(21) Appl. No.: 16/439,738

(22) Filed: Jun. 13, 2019

(51) Int. Cl. A01K 63/00; H02M 3/158; H02M 7/04

(52) U.S. Cl. CPC A01K 63/006; H02M 7/043; H02M 3/1582

(57) ABSTRACT

The present invention relates to an aquarium power adapter and an aquarium power supply device. The aquarium power adapter of the present invention has a boost/buck circuit having an input port and a plurality of output ports, and the input port is connected to a DC output port of the aquarium power supply. The first DC current is stepped up or stepped down by the boost/buck circuit, and the second direct current of higher or lower voltage is output from the output port to each electrical device, so that only one power adapter is needed, and correspondingly, only one power supply is required.

### BACKGROUND OF THE INVENTION

### Field of the Invention

The invention relates to an electrical device for an aquarium, and more particularly to an aquarium power adapter and an aquarium power supply system.

### Description of the Related Art

Aquariums often use some electrical equipment, such as pumps, heaters, lighting fixtures, etc. These electrical equipment often have their own AC-to-DC adapters. As shown in FIG. 1, the pump P, the heating device H and the lighting fixture L have their own AC-to-DC adapters A1 and A2. The input voltages of the adapters A1 and A2 are both 110V or 220V, which increases the complexity of the overall device. The adapters A1 and A2 takes much time to maintain and organize, and they also easily affect the appearance of the aquarium. In addition, the adapters with a high voltage input next to the aquarium may also cause a safety problem.

### BRIEF SUMMARY OF THE INVENTION

The present invention provides an aquarium power adapter and an aquarium power supply system. The aquarium power adapter of the present invention includes a boost/buck circuit which has an input port and a plurality of output ports. The input port is connected to a direct current output port of the power supply system. A first direct current is input to the input port and boosted or bucked through the boost/buck circuit, and a second direct current having a higher or lower voltage is output through the output port. Therefore, only one power adapter is needed for the plurality of electrical devices, and correspondingly, only one power supply system is needed.

The aquarium power adapter in accordance with an exemplary embodiment of the invention includes a housing disposed on an outer wall of an aquarium, a circuit board disposed in the housing, a boost/buck circuit disposed on the circuit board and comprising an input port and a plurality of output ports, wherein a first direct current is input to the input port and a second direct current is output from at least one of the output ports, an input connector electrically connected to the input port; and a plurality of output connectors electrically connected to the output ports respectively.

The aquarium power supply system in accordance with an exemplary embodiment of the invention includes a power supply comprising an alternating current input port and a direct current output port, wherein an alternating current is input into an AC-DC converting circuit through the alternating current input port, and a first direct current is output from the direct current output port; and a power adapter comprising a boost/buck circuit, wherein the boost/buck circuit comprises an input port and a plurality of output ports, wherein the first direct current is input to the input port and a second direct current is output from at least one of the output ports.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional aquarium with several power supply devices;

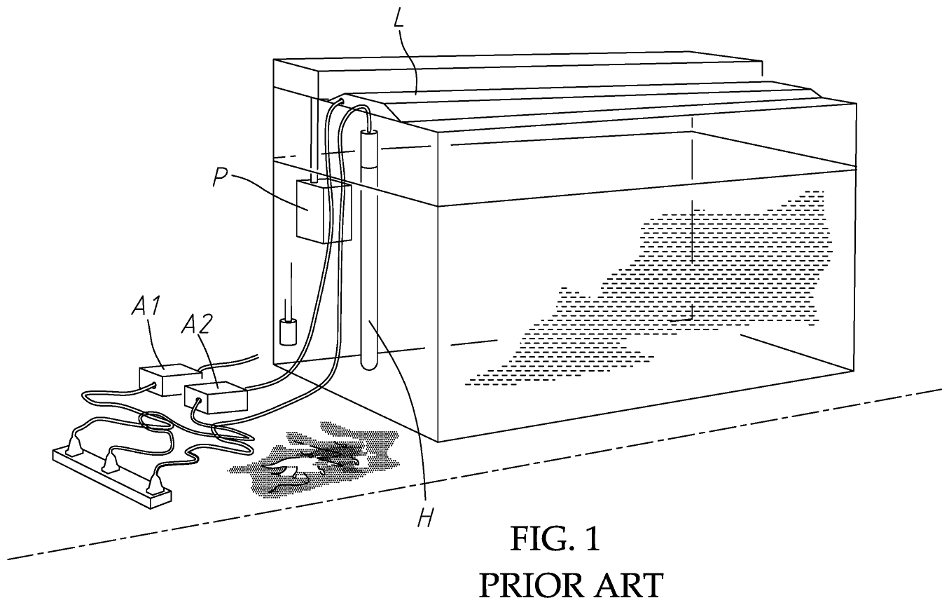

FIG. 2 is a perspective view of an aquarium power adapter of the present invention;

FIG. 3 is a partially exploded view of the aquarium power adapter of FIG. 2;

FIG. 4 is a planar schematic view of a circuit board, an input connector and an output connector of the power adapter of FIG. 2;

FIG. 5 is a schematic view of an embodiment of a power supply system of the present invention;

FIG. 6 depicts a usage condition of a power supply system of the present invention; and

FIG. 7 depicts another usage condition of a power supply system of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

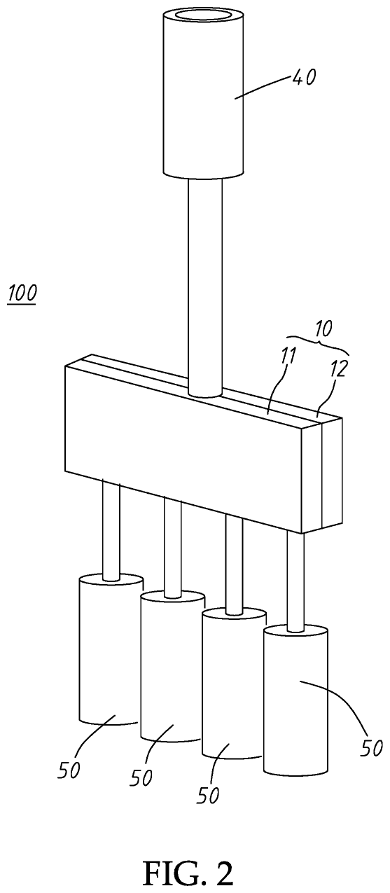

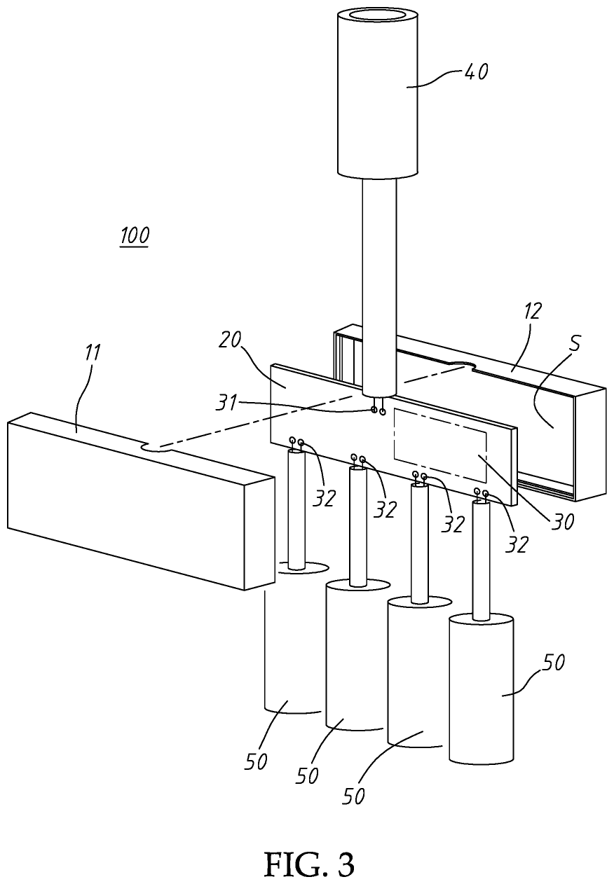

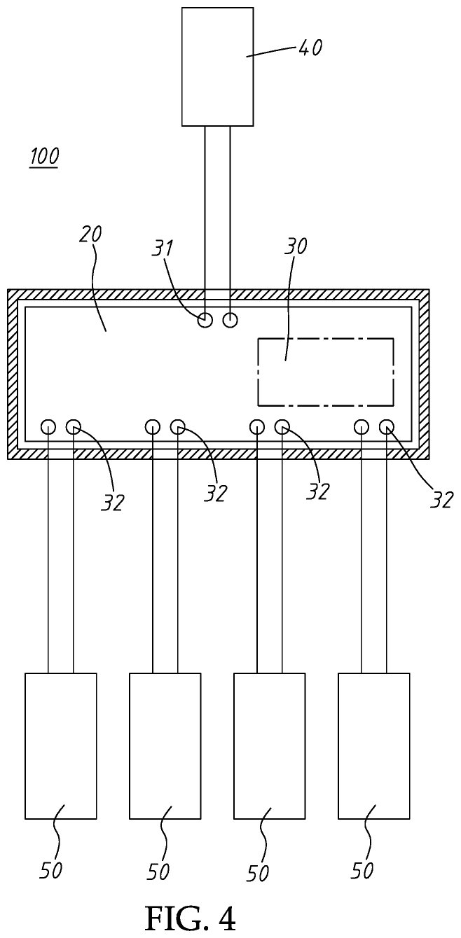

Referring to FIGS. 2, 3 and 4, an embodiment of an aquarium power adapter of the present invention is illustrated. The aquarium power adapter 100 includes a housing 10, a circuit board 20, a boost/buck circuit 30, a input connector 40 and a plurality of output connector 50.

The housing 10 is a flat rectangular body and can be disposed on an outer wall of an aquarium. The housing 10 includes a first half housing 11 and a second half housing 12, and the first half housing 11 and a second half housing 12 are combined to form an accommodating space S. The circuit board 20 is disposed in the accommodating space S. The boost/buck circuit 30 is formed on the circuit board 20. The boost/buck circuit 30 has an input port 31 and a plurality of output ports 32. A first direct current is input to the input port 31, and a second direct current is output from at least one of the output ports 32. The boost/buck circuit 30 can be a combination of a boost circuit and a buck circuit, such as a circuit including an inductor, a capacitor, and a diode, so that the voltage of the second direct current can be higher or lower than the voltage of the first direct current. For example, the first direct current may be an output direct current through an AC/DC transformer. For example, the AC/DC transformer converts an alternating current of 220V to a first direct current of 24V. The first direct current having a voltage of 24V may be converted into a second direct current having a voltage of 12V via the boost/buck circuit 30.

The input connector 40 is electrically connected to the input port 31 of the boost/buck circuit 30. The plurality of output connectors 50 are electrically connected to the output ports 32 of the boost/buck circuit 30, respectively. The various electrical equipment used in the aquarium, such as water pumps, heaters or lamps, have different operating voltages. Therefore the voltage of the second direct current through each of the output connectors 50 can also be adjusted for the electrical equipment. In addition, the input connector 40 and the output connectors 50 are electrically connected to the circuit board 20 via opposite sides of the housing 10.

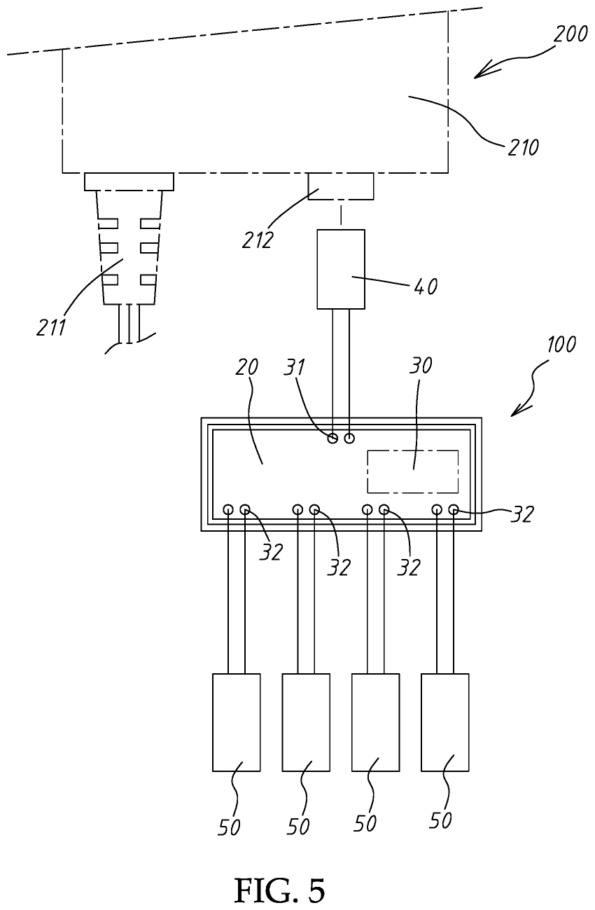

Referring to FIG. 5, an embodiment of an aquarium power supply device of the present invention is disclosed. The aquarium power supply device 200 of the present invention includes a power supply 210, which includes an AC/DC converting circuit, an alternating current input port 211, and a direct current output port 212. An alternating current is input to the AC/DC converting circuit via the alternating current input port 211. A first direct current is output from the direct current output port 212. The aquarium power supply device 200 of the present invention further includes a power adapter 100 as described above, which includes a boost/buck circuit 30. The boost/buck circuit 30 has an input port 31 and a plurality of output ports 32. The first direct current is input to the input port 31 and is output from the output ports 32.

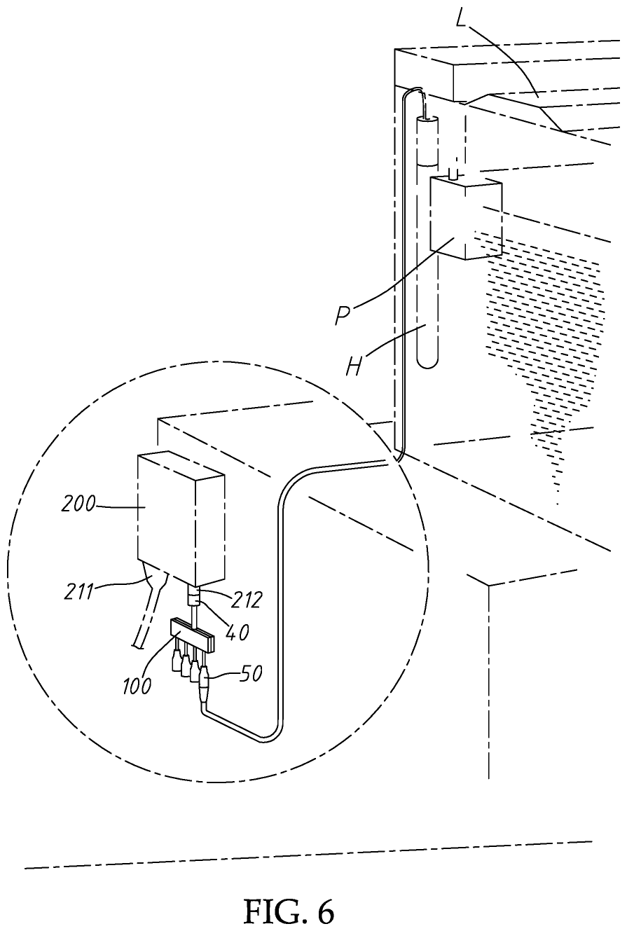

As shown in FIG. 6, the first direct current is stepped up to be the second direct current, and the second direct current is output to the heater of the aquarium via the output terminal 32.

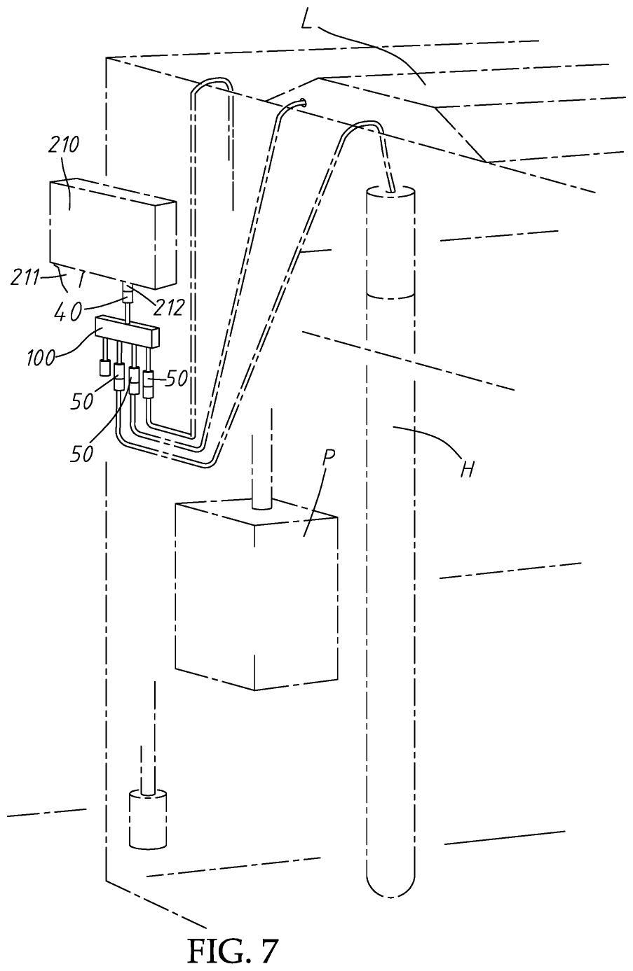

As shown in FIG. 7, the second direct current is output to the electric equipment such as the heater H, the water pump P, and the lamp L of the aquarium via the respective output ports 32.

The aquarium power adapter 100 of the present invention has a boost/buck circuit 30. The boost/buck circuit 30 has an input port 31 and a plurality of output ports 32. A first direct current is input to the input port 31, and a second direct current is output from at least one of the plurality of output ports 32, which can be provided to a plurality of electrical devices for the aquarium. Therefore, only one power supply devices is needed for the plurality of electrical devices, thereby not only reducing the complexity of the device, but also avoiding the safety problem brought by the high voltage.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An aquarium power adapter, comprising:
a housing disposed on an outer wall of an aquarium;
a circuit board disposed in the housing;
a boost/buck circuit disposed on the circuit board and comprising an input port and a plurality of output ports, wherein a first direct current is input to the input port and a second direct current is output from at least one of the output ports;
art input connector electrically connected to the input port; and
a plurality of output connectors electrically connected to the output ports respectively.

2. The aquarium power adapter as claimed in claim 1, wherein the first direct current has a voltage greater than that of the second direct current.

3. The aquarium power adapter as claimed in claim 1, wherein the first direct current has a voltage smaller than that of the second direct current.

4. The aquarium power adapter as claimed in claim 1, wherein the second direct current has a voltage of 24 volt.

5. The aquarium power adapter as claimed in claim 1, wherein the second direct current has a voltage of 12 volt.

6. The aquarium power adapter as claimed in claim 1, wherein the input connector and the output connectors are electrically connected to the circuit board through two opposite sides of the housing.

7. The aquarium power adapter as claimed in claim 1, wherein the housing comprises a first half housing and a second half housing, the first half housing and the second half housing are combined to form an accommodating space, and the circuit board is disposed in the accommodating space.

8. An aquarium power supply system, comprising:
a power supply comprising an alternating current input port, a direct current output port and an AC-DC converting circuit, wherein an alternating current is input into the AC-DC converting circuit through the alternating current input port, and a first direct current is output from the direct current output port; and
a power adapter comprising a boost/buck circuit, wherein the boost/buck circuit comprises an input port and a plurality of output ports, wherein the first direct current is input to the input port and a second direct current is output from at least one of the output ports.

9. The aquarium power supply system as claimed in claim 8, wherein the first direct current has a voltage greater than that of the second direct current.

10. The aquarium power supply system as claimed in claim 8, wherein the first direct current has a voltage smaller than that of the second direct current.

11. The aquarium power supply system as claimed in claim 8, wherein the second direct current has a voltage of 24 volt.

12. The aquarium power supply system as claimed in claim 8, wherein the second direct current has a voltage of 12 volt.
